(19) United States
(12) Patent Application Publication
(10) Pub. No.: US 2019/0109829 A1
(43) Pub. Date: Apr. 11, 2019

(54) APPARATUS AND METHOD FOR STORING DEVICE DATA IN INTERNET-OF-THINGS ENVIRONMENT

(71) Applicant: Electronics and Telecommunications Research Institute, Daejeon (KR)

(72) Inventors: Young-Sae KIM, Daejeon (KR); Dae-Won KIM, Daejeon (KR); Yong-Hyuk MOON, Daejeon (KR); Seung-Yong YOON, Daejeon (KR); Jin-Hee HAN, Daejeon (KR); Jeong-Nyeo KIM, Daejeon (KR); Jae-Deok LIM, Sejong-si (KR)

(21) Appl. No.: 16/011,957

(22) Filed: Jun. 19, 2018

(30) Foreign Application Priority Data
Oct. 11, 2017 (KR) 10-2017-0131243

(51) Int. Cl. H04L 29/06; H04L 29/08; G06F 21/44; H04L 9/08

(52) U.S. Cl. CPC H04L 63/0428; H04L 67/1097; H04L 63/067; H04L 67/12; G06F 21/44; H04L 9/0861; H04L 67/1095; H04L 63/08

(57) ABSTRACT

An apparatus and method for storing device data in an IoT environment. An apparatus for providing a data storage function includes an authentication unit for performing device authentication with a data storage-requesting device and performing data storage authentication with the data storage-requesting device, a data storage unit for storing encryption key basis information, used to generate an encryption key for data encryption, and encrypted data, a request message processing unit for processing a processing request message for the encrypted data received from the data storage-requesting device using the data storage unit, and a communication unit for receiving the processing request message from the data storage-requesting device and transmitting results of processing to the data storage-requesting device.

### CROSS REFERENCE TO RELATED APPLICATION

This application claims the benefit of Korean Patent Application No. 10-2017-0131243, filed Oct. 11, 2017, which is hereby incorporated by reference in its entirety into this application,

### BACKGROUND OF THE INVENTION

### 1. Technical Field

The present invention relates generally to an apparatus and method for providing a function of storing data of devices in an Internet-of-Things (IoT) environment such as a smart home, and more particularly, to an efficient data storage method and apparatus that store data of IoT devices using a separate device within a local network in an IoT environment.

### 2. Description of Related Art

With the development of Internet-of-Things (IoT) technology, services in an IoT environment such as a smart home in which connectivity is provided to various devices and useful functions are installed to provide new services for users have been realized. Also, with the development of related technology, there is a tendency for a wide variety of devices and services to appear.

In particular, in device fields, the number of low-power consumption and lightweight devices, such as sensor devices that enable acquisition of valuable information, which is a core element of new service creation, has explosively increased.

However, the principal purpose of low-specification devices such as sensor devices is to provide necessary functions using only the minimum specification, and thus there are some cases where the low-specification devices are not equipped with a data storage function and with the resources required for the function.

However, with the advent of new IoT services, a data storage function may be required even for devices having no data storage function. Therefore, a problem may arise in that, from the standpoint of functionality, devices incapable of storing data cannot be applied to those services or can only be limitedly applied thereto. Further, from the standpoint of security, pieces of data stored in the devices are vulnerable to attacks such as forgery or hacking, and thus a function of securely storing data also needs to be provided.

The above-described background technology is technological information that was possessed by the present applicant to devise the present invention or that was acquired by the present applicant during the procedure for devising the present invention, and thus such information cannot be construed to be known technology that was open to the public before the tiling of the present invention.

### SUMMARY OF THE INVENTION

Accordingly, the present invention has been made keeping in mind the above problems occurring in the prior art, and an object of the present invention is to provide a function of storing data of IoT devices using resources such as the gateway or the management server of a local IoT network.

Another object of the present invention is to provide an apparatus and method that encrypt and store data using a one-time encryption key so as to securely store data.

In accordance with an aspect of the present invention to accomplish the above objects, there is provided an apparatus for providing a data storage function, including an authentication unit for performing device authentication with a data storage-requesting device and performing data storage authentication with the data storage-requesting device; a data storage unit for storing encryption key basis information, used to generate an encryption key for data encryption, and encrypted data; a request message processing unit for processing a processing request message for the encrypted data received from the data storage-requesting device using the data storage unit; and a communication unit for receiving the processing request message from the data storage-requesting device and transmitting results of processing to the data storage-requesting device.

The encryption key basis information may include a device ID for identifying the data storage-requesting device and a data ID for identifying encryption target data, and the authentication unit may be configured to exchange the device ID with the data storage-requesting device when the data storage authentication is performed.

The request message processing unit may be configured to, when the processing request message is a data store message, store encrypted storage target data and encryption key basis information corresponding to the encrypted storage target data in the data storage unit, and when the processing request message is a data delete message, delete encrypted deletion target data and encryption key basis information corresponding to the encrypted deletion target data which are stored in the data storage unit.

The encryption key basis information may further include synchronization information for generating a one-time encryption key, the authentication unit may be configured to transmit the synchronization information to the data storage-requesting device when the data storage authentication is performed, and the encryption key may be a one-time encryption key generated using the synchronization information.

The synchronization information may include at least one of time synchronization information and counter synchronization information.

The apparatus may further include an encryption key generation unit for generating an encryption key using a method identical to that of the data storage-requesting device based on the encryption key basis information, and an encryption information update unit for, when the processing request message is a data read message, updating encryption information by decrypting encrypted read target data using an encryption key at a storage time and by encrypting the decrypted data using an encryption key at a read time, wherein the request message processing unit may be configured to, when the processing request message is the data read message, return encrypted data, in which the encryption information is updated, to the data storage-requesting device.

The processing request message may include tag information including at least one of information about whether data is encrypted and information about whether secure storage is used, and the data storage unit may be configured to provide a secure storage function depending on whether the secure storage has been enabled in the tag information.

In accordance with another aspect of the present invention to accomplish the above objects, there is provided a data storage method, including performing device authentication with a data storage-requesting device; performing data storage authentication with the data storage-requesting device; receiving a processing request message for encrypted data from the data storage-requesting device; processing the processing request message using a data storage unit which stores encryption key basis information, used to generate an encryption key for data encryption, and encrypted data; and transmitting results of processing to the data storage-requesting device.

The encryption key basis information may include a device ID for identifying the data storage-requesting device and a data ID for identifying encryption target data, and performing the data storage authentication may be configured to exchange the device ID with the data storage-requesting device.

Processing the processing request message may include, when the processing request message is a data store message, storing encrypted storage target data and encryption key basis information corresponding to the encrypted storage target data in the data storage unit; and when the processing request message is a data delete message, deleting encrypted deletion target data and encryption key basis information corresponding to the encrypted deletion target data which are stored in the data storage unit.

The encryption key basis information may further include synchronization information for generating a one-time encryption key, performing the data storage authentication may be configured to transmit the synchronization information to the data storage-requesting device, and the encryption key may be a one-time encryption key generated using the synchronization information.

The synchronization information may include at least one of time synchronization information and counter synchronization information.

The data storage method may further include generating an encryption key using a method identical to that of the data storage-requesting device based on the encryption key basis information; and when the processing request message is a data read message, updating encryption information by decrypting encrypted read target data using an encryption key at a storage time and by encrypting the decrypted data using an encryption key at a read time, wherein processing the processing request message may be configured to, when the processing request message is the data read message, return encrypted data, in which the encryption information is updated, to the data storage-requesting device.

The processing request message may include tag information including at least one of information about whether data is encrypted data and information about whether secure storage is used, and storing the data may be configured to provide a secure storage function depending on whether the secure storage has been enabled in the tag information.

In accordance with a further aspect of the present invention to accomplish the above objects, there is provided a data storage-requesting device, including an authentication unit for performing device authentication with a data storage function provision apparatus and performing data storage authentication with the data storage function provision apparatus; an encryption key generation unit for generating an encryption key using a method identical to that of the data storage function provision apparatus using encryption key basis information; an encryption/decryption unit for encrypting storage target data or decrypting encrypted data received from the data storage function provision apparatus; a request message generation unit for generating a processing request message for requesting the data storage function provision apparatus to process data; and a communication unit for sending the processing request message to the data storage function provision apparatus and receiving results of processing from the data storage function provision apparatus,

The encryption key basis information may include a device ID for identifying the data storage-requesting device and a data ID for identifying encryption target data, and the authentication unit may be configured to exchange the device ID with the data storage function provision apparatus when the data storage authentication is performed.

The request message generation unit may be configured to, when storage of data is requested, generate a message for requesting the data storage function provision apparatus to store therein encrypted storage target data and encryption key basis information corresponding to the encrypted storage target data, and when deletion of data is requested, generate a message for requesting the data storage function provision apparatus to delete encrypted deletion target data and encryption key basis information corresponding to the encrypted deletion target data which are stored in the data storage function provision apparatus.

The encryption key basis information may further include synchronization information for generating a one-time encryption key, the authentication unit may be configured to receive the synchronization information from the data storage function provision apparatus when the data storage authentication is performed, and the encryption key may be a one-time encryption key generated using the synchronization information.

The request message generation unit may be configured to, when reading of data is requested, generate a message for requesting the data storage function provision apparatus to update encryption information by decrypting encrypted read target data using an encryption key at a storage time and by encrypting decrypted data using an encryption key at a read time, and to return the read target data.

The processing request message may include tag information including at least one of information about whether data is encrypted and information about whether secure storage is used, and the data storage function provision apparatus is configured to provide a secure storage function depending on whether the secure storage has been enabled in the tag information. In connection with this, Korean Patent No. 10-1616795 discloses a technology related to “Method for manage private key file of public key infrastructure and system thereof”.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating the configuration of a data storage system according to an embodiment of the present invention;

FIG. 3 is a block diagram illustrating an example of the data storage-requesting devices illustrated in FIGS. 1 and 2;

FIG. 4 is a block diagram illustrating an example of the data storage function provision apparatus illustrated in FIGS. 1 and 2;

FIG. 5 is an operation flowchart illustrating a data storage method performed by the data storage-requesting device according to an embodiment of the present invention;

FIG. 6 is an operation flowchart illustrating a data storage method performed by the data storage function provision apparatus according to an embodiment of the present invention;

FIG. 7 is an operation flowchart illustrating an example of the step of performing data storage authentication, illustrated in FIG. 5;

FIG. 8 is an operation flowchart illustrating an example of the step of performing data storage authentication, illustrated in FIG. 5;

FIG. 9 is an operation flowchart illustrating an example of the step of performing data storage authentication, illustrated in FIG. 6;

FIG. 10 is operation flowchart illustrating an example of the step of performing data storage authentication, illustrated in FIG. 6;

FIG. 11 is an operation flowchart illustrating an example of the step of generating a data-processing request message, illustrated in FIG. 5;

FIG. 12 is an operation flowchart illustrating an example of the step of processing data, illustrated in FIG. 6;

FIG. 13 is an operation flowchart illustrating a data storage method according to an embodiment of the present invention;

FIG. 14 is an operation flowchart illustrating a data-processing method according to an embodiment of the present invention;

FIG. 15 is a diagram illustrating an example of a data-processing request message according to an embodiment of the present invention;

FIG. 16 is a diagram illustrating an example of device setting information according to an embodiment of the present invention;

FIG. 17 is a diagram illustrating an example of data setting information according to an embodiment of the present invention; and

FIG. 18 is a diagram illustrating a method for generating a one-time key according to an embodiment of the present invention.

### DESCRIPTION OF THE PREFERRED EMBODIMENTS

The present invention may be variously changed and may have various embodiments, and specific embodiments will be described in detail below with reference to the attached drawings. The advantages and features of the present invention and methods for achieving them will be more clearly understood from the following detailed description taken in conjunction with the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

However, the present invention is not limited to the following embodiments, but some or all of the following embodiments can be selectively combined and configured so that various modifications are possible. In the following embodiments, terms such as “first” and “second” are not intended to restrict the meanings of components, and are merely intended to distinguish one component from other components. A singular expression includes a plural expression unless a description to the contrary is specifically pointed out in context. In the present specification, it should be understood that the terms such as “include” or “have” are merely intended to indicate that features or components described in the present specification are present, and are not intended to exclude the possibility that one or more other features or components will be present or added.

Embodiments of the present invention will be described in detail with reference to the accompanying drawings. In the following description of the present invention, the same reference numerals are used to designate the same or similar elements throughout the drawings, and repeated descriptions of the same components will be omitted.

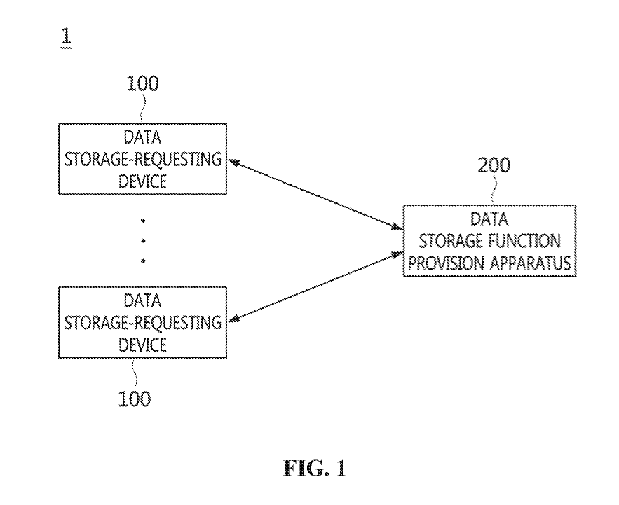

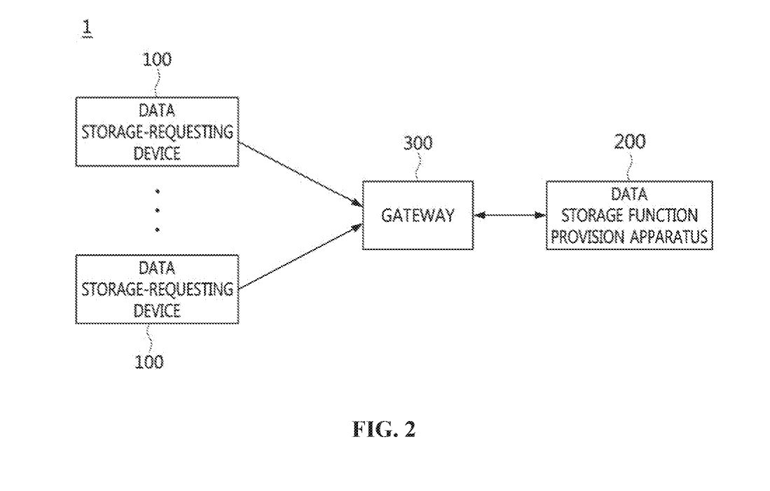

FIGS. 1 and 2 are diagrams illustrating the configuration of a data storage system 1 according to an embodiment of the present invention.

Referring to FIGS. 1 and 2, in the data storage system 1 according to the embodiment of the present invention, an apparatus 200 for providing a data storage function (hereinafter referred to as a “data storage function provision apparatus 200”) is connected to one or more data storage-requesting devices 100.

Here, the data storage function provision apparatus 200 may also be connected to one or more data storage-requesting devices 100 through a gateway 300.

In particular, some data storage-requesting devices 100 may be directly connected to the data storage function provision apparatus 200, and some other data storage-requesting devices 100 may be connected to the data storage function provision apparatus 200 through the gateway 300.

Here, mutual connection may be implemented via wired communication, wireless communication, wired/wireless communication, or the like.

The data storage-requesting devices 100 according to the embodiment of the present invention may include various electronic devices, user terminals, IoT devices, etc., which request the storage of data from the data storage function provision apparatus 200.

Here, the data storage-requesting devices 100 may include low-specification devices, devices which do not provide a storage function, devices which provide a storage function, etc.

For example, the data storage-requesting devices 100 may include devices such as an illumination sensor-based device (e.g. lighting or the like), a temperature sensor-based device (e.g. temperature controller or the like), and a gas detection sensor-based device gas detector or the like), which can sense and acquire specific information and additionally include an actuating function.

The data storage function provision apparatus 200 may store data in place of the corresponding data storage-requesting device 100 in response to a data storage request from the data storage-requesting device 100, and may manage the stored data in place of the data storage-requesting device 100.

Here, the data storage function provision apparatus 200 may be a management server which takes charge of the configuration and management of the data storage-requesting devices 100.

Here, the data storage function provision apparatus 200 may be a Personal Computer (PC) equipped with specifications sufficient to execute management software which takes charge of management, setting, control, etc. of the data storage-requesting devices 100, which are the targets to be managed.

The gateway 300 configures a local network with one or more data storage-requesting devices 100, and takes charge of connection to an external network to connect the data storage-requesting devices 100 to the data storage function provision apparatus 200.

Here, the gateway 300 may also be implemented as a single physical device integrated with the data storage function provision apparatus 200.

The gateway 300 may be implemented as a wired sharer, a wireless sharer, or a wired/wireless sharer.

That is, since data collected or generated by the data storage-requesting devices 100 is stored in the data storage function provision apparatus 200 in place of the data storage-requesting devices 100, the data may be stored regardless of whether the data storage-requesting devices 100 provide a storage function. Further, security may be improved by encrypting and storing data, as will be described later.

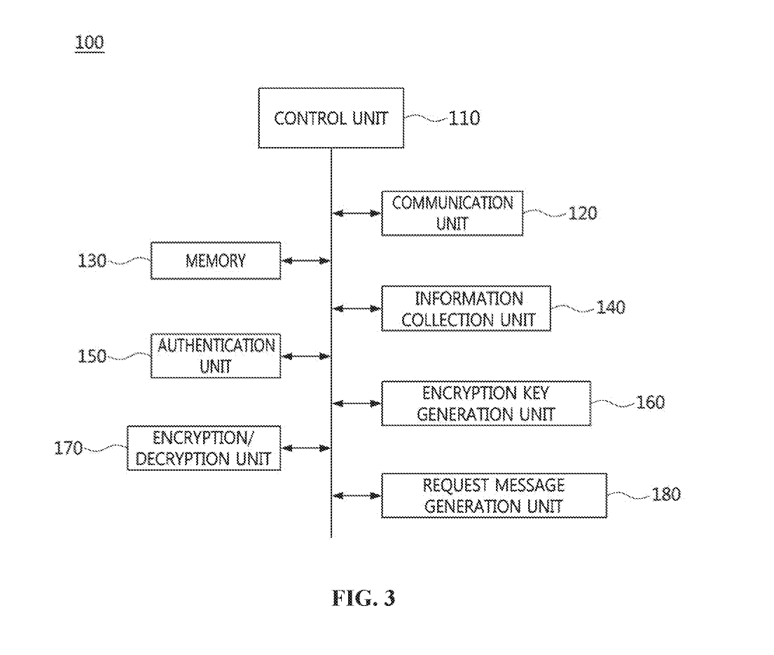

FIG. 3 is a block diagram illustrating an example of the data storage-requesting device 100 illustrated in FIGS. 1 and 2.

Referring to FIG. 3, the data storage-requesting device 100 according to an embodiment of the present invention includes a control unit 110, a communication unit 120, memory 130, an information collection unit 140, an authentication unit 150, an encryption key generation unit 160, an encryption/decryption unit 170, and a request message generation unit 180.

In detail, the control unit 110, which is a kind of Central Processing Unit (CPU), controls the overall process for requesting the storage of data. That is, the control unit 110 may provide various types of functions by controlling the information collection unit 140, the authentication unit 150, the encryption key generation unit 160, the encryption/decryption unit 170, and the request message generation unit 180.

Here, the control unit 110 may include all types of devices capable of processing data, such as a processor. Here, the term “processor” may refer to a data-processing device that has a physically structured circuit to perform functions represented by code or instructions included in a program and that is embedded in hardware. In this way, examples of the data-processing device embedded in hardware may include, but are not limited to, processing devices such as a microprocessor, a CPU, a processor core, a multiprocessor, an Application-Specific integrated Circuit (ASIC), and a Field-Programmable Gate Array (FPGA).

The communication unit 120 provides a communication interface required so as to transfer transmission/reception signals between the data storage-requesting device 100, a data storage function provision apparatus (see 200 of FIG. 2), and a gateway (see 300 of FIG. 2).

Here, the communication unit 120 may be a device including hardware and software required in order to transmit/receive signals, such as control signals or data signals, to/from other network devices through wired/wireless connection.

The memory 130 functions to temporarily or permanently store data processed by the control unit 110. Here, the memory 130 may include, but is not limited to, magnetic storage media or flash storage media.

The information collection unit 140 collects information or data required for the generation of data to be stored. Here, the information collection unit 140 may include various types of sensors (e.g. a temperature sensor, a humidity sensor, an illumination sensor, a gas detection sensor, etc.) of IoT devices, but the scope of the present invention is not limited thereto.

The authentication unit 150 performs mutual device authentication required for communication with the data storage function provision apparatus (see 200 of FIG. 2) and performs data storage authentication required for storage of data.

Here, the authentication unit 150 may use authentication methods supported by devices which perform authentication, among various authentication methods, when mutual device authentication is performed. That is, mutual device authentication may be performed based on the authentication method of the corresponding IoT system.

Here, as a result of mutual device authentication by the authentication unit 150, the data storage-requesting device 100 and the data storage function provision apparatus (see 200 of FIG. 2) may share the same session key with each other.

The authentication unit 150 may perform mutual device authentication at each time, intermittently perform mutual device authentication, or initially perform mutual device authentication only once, depending on the authentication method of the corresponding IoT system.

Here, the authentication unit 150 may generate and share encryption key basis information that is to be used to generate an encryption key during data storage authentication. Here, the encryption key is used to improve security by encrypting data to be stored.

Here, when data storage authentication is performed, the authentication unit 150 may transmit the device ID of the corresponding data storage-requesting device 100 and a first random number encrypted with a session key to the data storage function provision apparatus (see 200 of FIG. 2), and may receive a second random number encrypted with the session key from the data storage function provision apparatus (see 200 of FIG. 2). Further, the encryption key basis information may include the device ID, the first random number, and the second random number. The device ID may be a value for identifying the data storage-requesting device 100 managed by the data storage function provision apparatus (see 200 of FIG. 2). In addition, the device ID may be used as a value required by the data storage function provision apparatus (see 200 of FIG. 2) to manage a data storage area.

Here, when data storage authentication is performed, the authentication unit 150 may additionally receive synchronization information from the data storage function provision apparatus (see 200 of FIG. 2), wherein the synchronization information may be used to generate a one-time encryption key as an encryption key fur data encryption. Here, the synchronization information may include one or more of time synchronization information and counter synchronization information. The encryption key basis information may further include the synchronization information.

Here, the encryption key basis information may be divided into device setting information and data setting information. The device setting information may include a device ID, a first random number, and a second random number, and the data setting information may include a data ID, a session key, and synchronization information. In particular, the device setting information and the data setting information may be values which are always shared by the data storage-requesting device 100 and the data storage function provision apparatus (see 200 of FIG. 2), and a required encryption key may be generated using the device setting information and the data setting information.

Here, the authentication unit 150 may receive only synchronization information from the data storage function provision apparatus (see 200 of FIG. 2) when a data storage request is not an initial data storage request during data storage authentication. The reason for this is that, during data storage authentication performed upon initial data storage, a device ID, a first random number encrypted with a session key, and a second random number encrypted with the session key are mutually shared, and thus there is no need to repeatedly transmit the device ID and the first and second random numbers.

Here, the authentication unit 150 may allow an initial data storage authentication procedure to be performed again, or may allow an existing data storage authentication value to be maintained without change, through a policy such as event setting or period setting.

That is, through data storage authentication, the data storage-requesting device 100 and the data storage function provision apparatus (see 200 of FIG. 2) may share the same device ID, the same first random number encrypted with the session key, and the same second random number encrypted with the session key, with each other, and may additionally share the same synchronization information with each other when a one-time encryption key is used for data encryption.

The encryption key generation unit 160 generates an encryption key to be used for data encryption using the encryption key basis information shared in the authentication procedure by the authentication unit 150.

Here, the encryption key generation unit 160 may generate the encryption key by using a device ID, a first random number, a second random number, the data ID of encryption target data, and a session key as the encryption key basis information. The data ID may be a value for identifying target data, and may be implemented using an identifier (ID) or a file name. Further, the device ID may also be used as a value required by the data storage function provision apparatus (see 200 of FIG. 2) to manage a data storage area.

Here, the encryption key generation unit 160 may generate a one-time encryption key by additionally using synchronization information as the encryption key basis information. For example, whenever a data storage function is performed, a one-time encryption key is newly generated, and thus security may be strengthened.

Here, the generation of the one-time encryption key may be performed based on a One-Time Password (OTP) generation technique. When the data storage-requesting device 100 and the data storage function provision apparatus (see 200 of FIG. 2) set initial synchronization information in synchronization with each other at the time of storage of initial data, a new encryption key may be simply generated by updating only the synchronization information when subsequent data is processed.

The encryption/decryption unit 170 encrypts data to be stored in the data storage function provision apparatus (see 200 of FIG. 2) or decrypts data read from the data storage function provision apparatus (see 200 of FIG. 2) using the encryption key generated by the encryption key generation unit 160. That is, the data read from the data storage function provision apparatus (see 200 of FIG. 2) is encrypted data.

The request message generation unit 180 generates a processing request message related to the storage of data that is to be transmitted to the data storage function provision apparatus (see 200 of FIG. 2).

Here, the request message generation unit 180 may generate a processing request message including a device ID, a data ID, a command type, data-related information, etc.

Further, the request message generation unit 180 may generate a processing request message which further includes tag information containing at least one of whether data is encrypted and whether secure storage is used. That is, the tag information may indicate the security strength of data that is transmitted.

The command type may include a data store (write) command, a data read command, a data delete command, a data storage authentication command, etc., and the data-related information may include encrypted data, data length information, etc. Also, the processing request message may be transmitted to the data storage function provision apparatus (see 200 of FIG. 2), thus enabling processing to be performed depending on the type of command.

For example, when the processing request message is a data storage request message, the command type is a “data store” command, and the processing request message may contain a device ID, a data ID, and data-related information such as encrypted data and data length information. Further, when the processing request message is a data deletion request message, the command type is a “data delete” command, and the processing request message may contain a device ID and a data ID.

In this way, the data storage-requesting device 100 performs device authentication and data storage authentication so as to store and manage data in the data storage function provision apparatus (see 200 of FIG. 2), and shares the encryption key basis information with the data storage function provision apparatus 200 based on the results of authentication. Further, when it is desired to store data, the data is encrypted with an encryption key generated using the encryption key basis information, and is transmitted to the data storage function provision apparatus (see 200 of FIG. 2), and thus the data may be stored. Furthermore, when it is desired to manage data, a message including a device ID, a data ID, and a command type is transmitted to the data storage function provision apparatus (see 200 of FIG. 2), and thus the data may be managed.

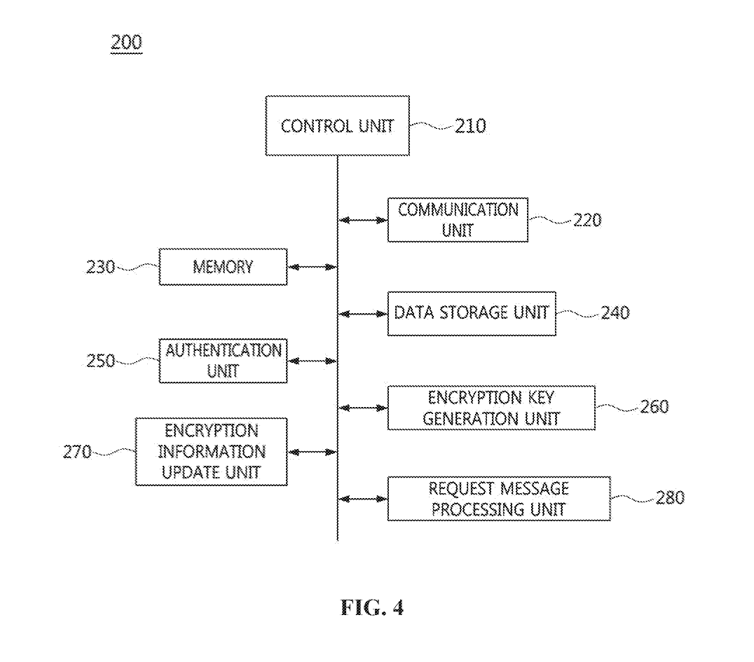

FIG. 4 is a block diagram illustrating an example of the data storage function provision apparatus 200 illustrated in FIGS. 1 and 2.

Referring to FIG. 4, the data storage function provision apparatus 200 according to an embodiment of the present invention includes a control unit 210, a communication unit 220, memory 230, a data storage unit 240, an authentication unit 250, an encryption key generation unit 260, an encryption information update unit 270, and a request message processing unit 280.

In detail, the control unit 210, which is a kind of CPU, controls the overall process for providing a data storage function. That is, the control unit 210 may provide various types of functions by controlling the data storage unit 240, the authentication unit 250, the encryption key generation unit 260, the encryption information update unit 270, and the request message processing unit 280.

Here, the control unit 210 may include all types of devices capable of processing data, such as a processor. Here, the term “processor” may refer to a data-processing device that has a physically structured circuit to perform functions represented by code or instructions included in a program and that is embedded in hardware. In this way, examples of the data-processing, device embedded in hardware may include, but are not limited to, processing devices such as a microprocessor, a CPU, a processor core, a multiprocessor, an Application-Specific Integrated Circuit (ASIC), and a Field-Programmable Gate Array (FPGA).

The communication unit 220 provides a communication interface required so as to transfer transmission/reception signals between the data storage function provision apparatus 200, a data storage-requesting device (see 100 of FIG. 2), and a gateway (see 300 of FIG. 2).

Here, the communication unit 220 may be a device including hardware and software required in order to transmit/receive signals, such as control signals or data signals, to/from other network devices through wired/wireless connection.

The memory 230 functions to temporarily or permanently store data processed by the control unit 210. Here, the memory 230 may include, but is not limited to, magnetic storage media or flash storage media.

The data storage unit 240 stores data, the storage and management of which have been requested by the data storage-requesting device (see 100 of FIG. 2).

In this case, the data storage unit 240 may store encrypted data, received from the data storage-requesting device (see 100 of FIG. 2), together with encryption key basis information corresponding to the encrypted data.

Here, the data storage unit 240 may autonomously provide a secure storage function or a safe storage function.

The authentication unit 250 performs mutual device authentication required for communication with the data storage-requesting device (see 100 of FIG. 2) and performs data storage authentication required for storage of data.

Here, the authentication unit 250 may use authentication methods supported by devices which perform authentication, among various authentication methods, when mutual device authentication is performed. That is, mutual device authentication may be performed based on the authentication method of the corresponding IoT system.

Here, the data storage-requesting device (see 100 of FIG. 2) and the data storage function provision apparatus 200 may share the same session key with each other based on the results of mutual device authentication by the authentication unit 250.

Here, the authentication unit 250 may generate and share encryption key basis information that is to be used to generate an encryption key during data storage authentication. Here, the encryption key is used to improve security by encrypting data to be stored.

Here, when data storage authentication is performed, the authentication unit 250 may receive the device ID of the data storage-requesting device (see 100 of FIG. 2) and a first random number encrypted with a session key from the data storage-requesting device 100, and may transmit a second random number encrypted with the session key to the data storage-requesting device (see 100 of FIG. 2). Further, the encryption key basis information may include the device ID, the first random number, and the second random number. The device ID may be a value for identifying the data storage-requesting device((see 100 of FIG. 2) managed by the data storage function provision apparatus 200. In addition, the device ID may be used as a value required by the data storage function provision apparatus 200 to manage a data storage area.

Here, when data storage authentication is performed, the authentication unit 250 may additionally transmit synchronization information to the data storage-requesting device (see 100 of FIG. 2), wherein the synchronization information may be used to generate a one-time encryption key as an encryption key for data encryption. The synchronization information may include one or more of time synchronization information and counter synchronization information. The encryption key basis information may further include the synchronization information.

Here, the authentication unit 250 may transmit only the synchronization information to the data storage-requesting device (see 100 of FIG. 2) when a data storage request is not an initial data storage request during data storage authentication. The reason for this is that, during data storage authentication performed upon initial data storage, a device ID, a first random number encrypted with a session key, and a second random number encrypted with the session key are mutually shared, and thus there is no need to repeatedly transmit the device ID and the first and second random numbers.

That is, through data storage authentication, the data storage-requesting device (see 100 of FIG. 2) and the data storage function provision apparatus 200 may share the same device ID, the same first random number encrypted with the session key, and the same second random number encrypted with the session key, with each other, and may additionally share the same synchronization information with each other when a one-time encryption key is used for data encryption.

The encryption key generation unit 260 generates an encryption key to be used for data encryption and decryption using the same method as the data storage-requesting device (see 100 of FIG. 2) using the encryption key basis information shared in the authentication procedure by the authentication unit 250. However, the encryption key generation unit 260 may not generate an encryption key when simply storing or deleting data, and may generate an encryption key in order to update encryption information when reading data.

For example, the data stored in the data storage unit 240 may be data encrypted by the data storage-requesting device (see 100 of FIG. 2), and may be transferred in an encrypted state to the data storage-requesting device 100 even when it is subsequently provided to the data storage-requesting device 100. However, when an encryption key at a data storage time and an encryption key at a data read time are different from each other, an encryption key may be generated so as to update the encryption information.

Here, the encryption key generation unit 260 may generate the encryption key by using a device ID, a first random number, a second random number, the data ID of encryption target data, and a session key as the encryption key basis information. The data ID may be a value for identifying target data, and may be implemented using an identifier (ID) or a file name. In addition, the data ID may be used as a value required by the data storage function provision apparatus 200 to manage a data storage area.

Here, the encryption key generation unit 260 may generate a one-time encryption key by additionally using synchronization information as the encryption key basis information. For example, whenever a data storage function is performed, a one-time encryption key is newly generated, and thus security may be strengthened.

Here, the generation of the one-time encryption key may be performed based on a One-Time Password (OTP) generation technique. When the data storage-requesting device (see 100 of FIG. 2) and the data storage function provision apparatus 200 set initial synchronization information in synchronization with each other at the time of storage of initial data, a new encryption key may be generated simply by updating only the synchronization information when subsequent data is processed.

Here, the one-time encryption key may be generated from an OTP function that uses secret (private) information and synchronization information, which are mutually shared, as input and that is implemented based on a hash function,

When the encryption key of data is changed, the encryption information update unit 270 updates encryption information so as to consider the change of the encryption key. For example, the case where an encryption key at a data storage time and an encryption key at a data read time are different from each other corresponds to that case.

Here, the encryption information update unit 270 uses a one-time encryption key to store data. When a data read request is received, the encryption information update unit 270 may update encryption information by decrypting encrypted data using an encryption key at the data storage time and by encrypting the decrypted data using a new encryption key at the data read time.

Here, the encryption information update unit 270 may update synchronization information for the encryption key basis information stored in the data storage unit 240 when updating the encryption information.

The request message processing unit 280 processes a processing request message related to the storage of data, received from the data storage-requesting device (see 100 of FIG. 2).

Here, the request message processing unit 280 may process a processing request message including a device ID, a data ID, a command type, data-related information, etc. For example, the area of the data storage unit 240 may be divided and separately managed using a device ID and a data ID, and the data-related information may be processed depending on the command type.

Here, the request message processing unit 280 may process the data-related information depending on tag information which is included in the processing request message and which includes information about at least one of whether data is encrypted and whether secure storage is used. For example, when secure storage is enabled in the tag information in response to a data storage request, the data may be stored by additionally utilizing a secure storage function autonomously supported by the data storage unit 240.

In this way, in order to store and manage the data of the data storage-requesting device (see 100 of FIG. 2), the data storage function provision apparatus 200 performs device authentication and data storage authentication and shares encryption key basis information with the data storage-requesting device 100 based on the results of authentication. Further, when it is desired to store data, data encrypted with an encryption key that is generated using the encryption key basis information may be received from the data storage-requesting device (see 100 of FIG. 2) and may then be stored. Further, when it is desired to manage data, a message including a device ID, a data ID, a command type, etc. is received from the data storage-requesting device (see 100 of FIG. 2), and thus the data may be managed.

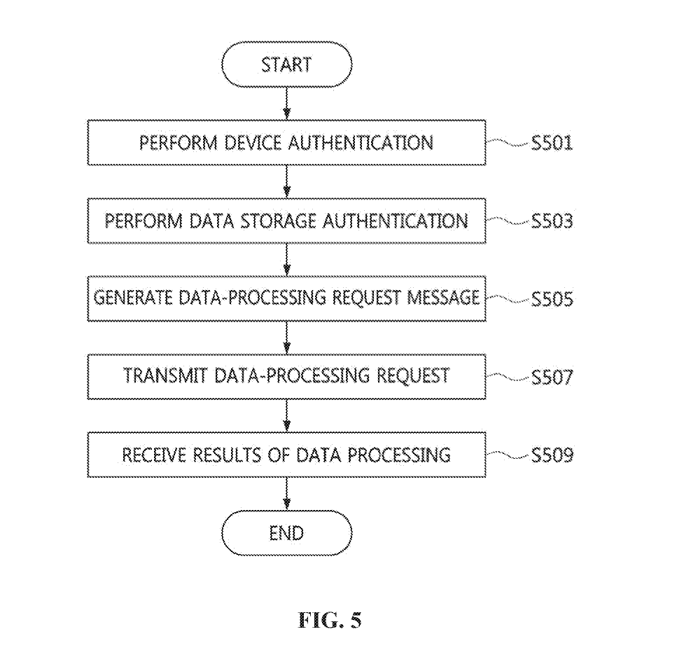

FIG. 5 is an operation flowchart illustrating a data storage method performed by the data storage-requesting device (see 100 of FIG. 2) according to an embodiment of the present invention.

Referring to FIG. 5, in the data storage method according to an embodiment of the present invention, the data storage-requesting device (see 100 of FIG. 2) performs device authentication with the data storage function provision apparatus (see 200 of FIG. 2) at step S501.

Here, the data storage-requesting device (see 100 of FIG. 2) and the data storage function provision apparatus (see 200 of FIG. 2) may share the same session key with each other based on the results of device authentication.

Next, in the data storage method according to the embodiment of the present invention, the data storage-requesting device (see 100 of FIG. 2) performs data storage authentication with the data storage function provision apparatus (see 200 of FIG. 2) at step S503. Here, data storage authentication is performed to encrypt and store data.

Next, in the data storage method according to the embodiment of the present invention, the data storage-requesting device (see 100 of FIG. 2) generates a data-processing request message at step S505.

Here, the data-processing request message may include a device ID, a data ID, a command type, data-related information, tag information, etc.

Further, in the data storage method according to the embodiment of the present invention, the data storage-requesting device (see 100 of FIG. 2) requests the data storage function provision apparatus (see 200 of FIG. 2) to process data by sending the data-processing request message thereto at step S507.

Furthermore, in the data storage method according to the embodiment of the present invention, the data storage-requesting device (see 100 of FIG. 2) receives the results of data processing from the data storage function provision apparatus (see 200 of FIG. 2) at step S509.

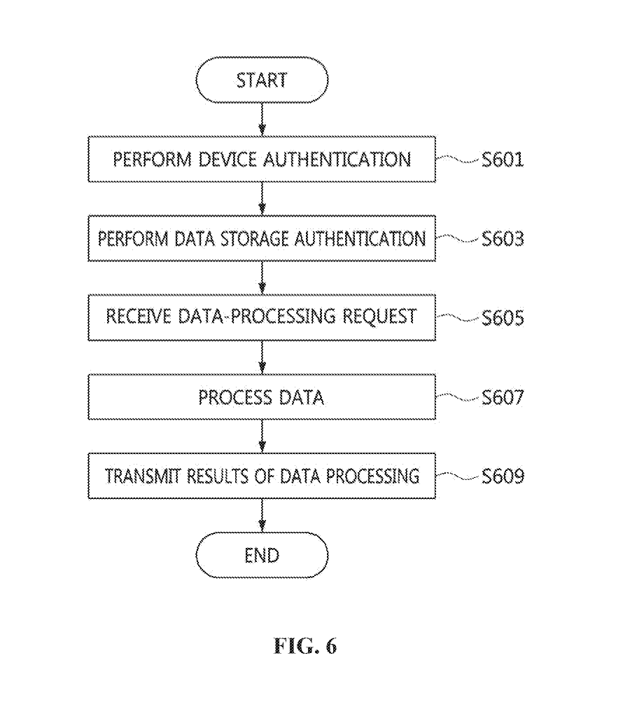

FIG. 6 is an operation flowchart illustrating a data storage method performed by the data storage function provision apparatus (see 200 of FIG. 2) according to an embodiment of the present invention.

Referring to FIG. 6, in the data storage method according to the embodiment of the present invention, the data storage function provision apparatus (see 200 of FIG. 2) performs device authentication with the data storage-requesting device (see 100 of FIG. 2) at step S601.

Here, the data storage-requesting device (see 100 of FIG. 2) and the data storage function provision apparatus (see 200 of FIG. 2) may share the same session key with each other as a result of device authentication.

Next, in the data storage method according to the embodiment of the present invention, the data storage function provision apparatus (see 200 of FIG. 2) performs data storage authentication with the data storage-requesting device (see 100 of FIG. 2) at step S603. Here, data storage authentication is performed to encrypt and store data.

Next, in the data storage method according to the embodiment of the present invention, the data storage function provision apparatus (see 200 of FIG. 2) receives a data-processing request message generated by the data storage-requesting device (see 100 of FIG. 2) at step S605.

Here, the data-processing request message may include a device ID, a data ID, a command type, data-related information, tag information, etc.

Further, in the data storage method according to the embodiment of the present invention, the data storage function provision apparatus (see 200 of FIG. 2) processes data in response to the received data-processing request message at step S607. Here, the processing of data may include the storage (writing), reading, deletion, etc. of data depending on the command type.

Furthermore, in the data storage method according to the embodiment of the present invention, the data storage function provision apparatus (see 200 of FIG. 2) transmits the results of data processing to the data storage-requesting device (see 100 of FIG. 2) at step S609.

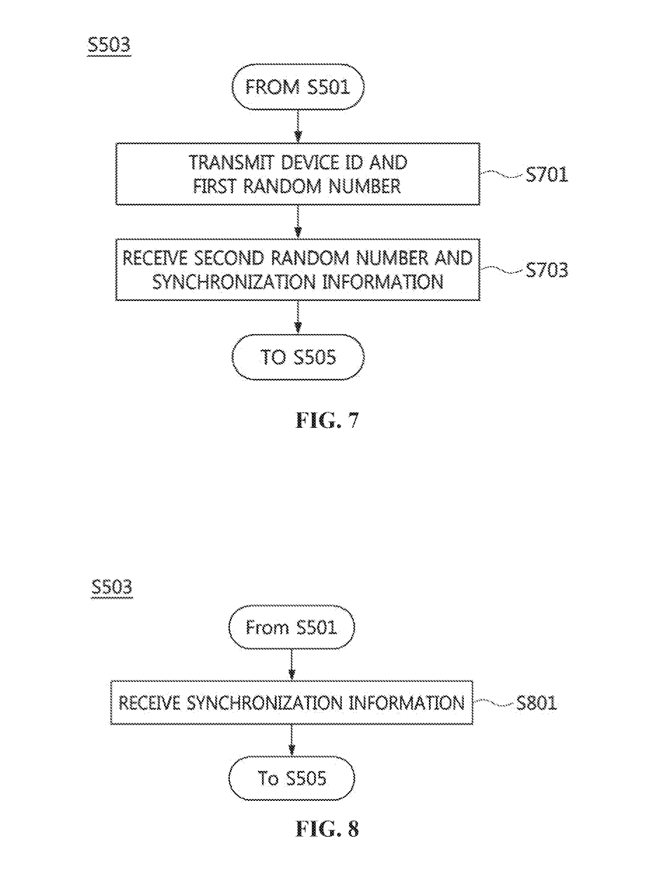

FIG. 7 is an operation flowchart illustrating an example of step S503 of performing data storage authentication illustrated in FIG. 5.

Referring to FIG. 7, in a procedure at step S503 of performing data storage authentication illustrated in FIG. 5, the data storage-requesting device (see 100 of FIG. 2) transmits a device ID and a first random number to the data storage function provision apparatus (see 200 of FIG. 2) at step S701. Here, the first random number may be a number encrypted with a session key.

Next, in the procedure at step S503 of performing data storage authentication illustrated in FIG. 5, the data storage-requesting device (see 100 of FIG. 2) receives a second random number and synchronization information from the data storage function provision apparatus (see 200 of FIG. 2) at step S703. Here, the second random number and the synchronization information may be those encrypted with the session key.

The synchronization information may be used to generate a one-time encryption key to be utilized when a data storage function is used.

FIG. 8 is an operation flowchart illustrating an example of step S503 of performing data storage authentication illustrated in FIG. 5.

Referring to FIG. 8, in a procedure at step S503 of performing data storage authentication illustrated in FIG. 5, the data storage-requesting device (see 100 of FIG. 2) receives synchronization information from the data storage function provision apparatus (see 200 of FIG. 2) at step S801. Here, the synchronization information may be information encrypted with a session key.

The reason for this is that it is sufficient if only synchronization information is updated in the state in which a device ID, a first random number encrypted with a session key, and a second random number encrypted with the session key are already shared.

FIG. 9 is an operation flowchart illustrating an example of step S603 of performing data storage authentication illustrated in FIG. 6.

Referring to FIG. 9, in a procedure at step S603 of performing data storage authentication illustrated in FIG. 6, the data storage function provision apparatus (see 200 of FIG. 2) receives a device ID and a first random number from the data storage-requesting device (see 100 of FIG. 2) at step S901. Here, the first random number may be a number encrypted with a session key.

Next, in the procedure at step S603 of performing data storage authentication illustrated in FIG. 6, the data storage function provision apparatus (see 200 of FIG. 2) transmits a second random number and synchronization information to the data storage-requesting device (see 100 of FIG. 2) at step S903. Here, the second random number and the synchronization information may be those encrypted with the session key.

The synchronization information may be used to generate a one-time encryption key to be utilized when a data storage function is used.

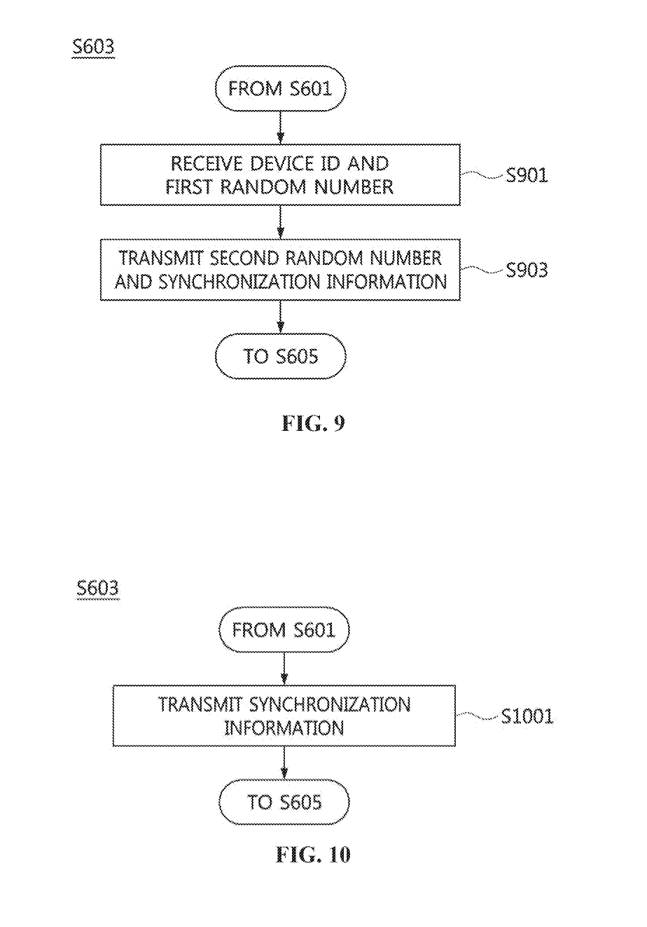

FIG. 10 is an operation flowchart illustrating an example of step S603 of performing data storage authentication illustrated in FIG. 6.

Referring to FIG. 10, in a procedure at step S603 of performing data storage authentication illustrated in FIG. 6, the data storage function provision apparatus (see 200 of FIG. 2) transmits synchronization information to the data storage-requesting device (see 100 of FIG. 2) at step S1001. Here, the synchronization information may be information encrypted with a session key.

The reason for this is that it is sufficient if only synchronization information is updated in the state in which a device ID, a first random number encrypted with a session key, and a second random number encrypted with the session key are already shared.

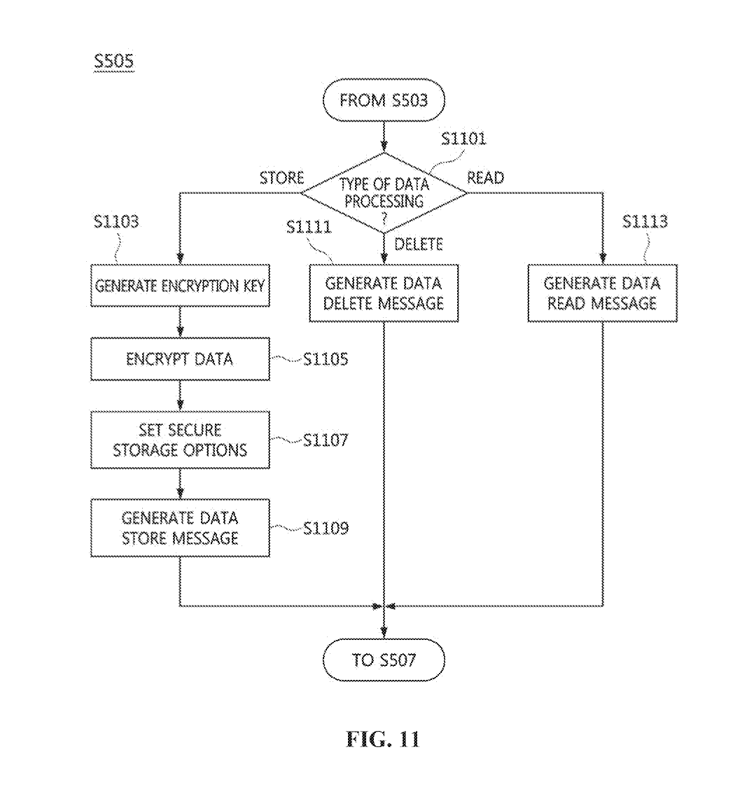

FIG. 11 is an operation flowchart illustrating an example of step S505 of generating a data-processing request message illustrated in FIG. 5.

Referring to FIG. 11, in a procedure at step S505 of generating a data-processing request message illustrated in FIG. 5, the data storage-requesting device (see 100 of FIG. 2) determines a command type indicating the type of data processing step S1101.

If it is determined at step S1101 that the command type is a data storage command, an encryption key for data storage is generated at step S1103, and storage target data is encrypted using the generated encryption key at step S1105. Next, the data storage-requesting device sets whether to use a safe storage function or a secure storage function supported by the data storage function provision apparatus (see 200 of FIG. 2) at step S1107, and generates a data store message at step S1109.

Here, the encryption key may be generated using encryption key basis information, and the encryption key basis information may be implemented using a device ID, a data ID, synchronization information, a first random number, a second random number, etc.

Here, the data store message may include information such as a device ID, a data ID, a data storage command, encrypted data, data length, and information about whether secure storage is used.

If it is determined at step S1101 that the command type is a data delete command, a data delete message is generated at step S1111.

Here, the data delete message may include information such as a device ID, a data ID, a data delete command, and information about whether secure storage is used.

If it is determined at step S1101 that the command type is a data read command, a data read message is generated at step S1113.

Here, the data read message may include information such as a device ID, a data ID, a data read command, and information about whether secure storage is used.

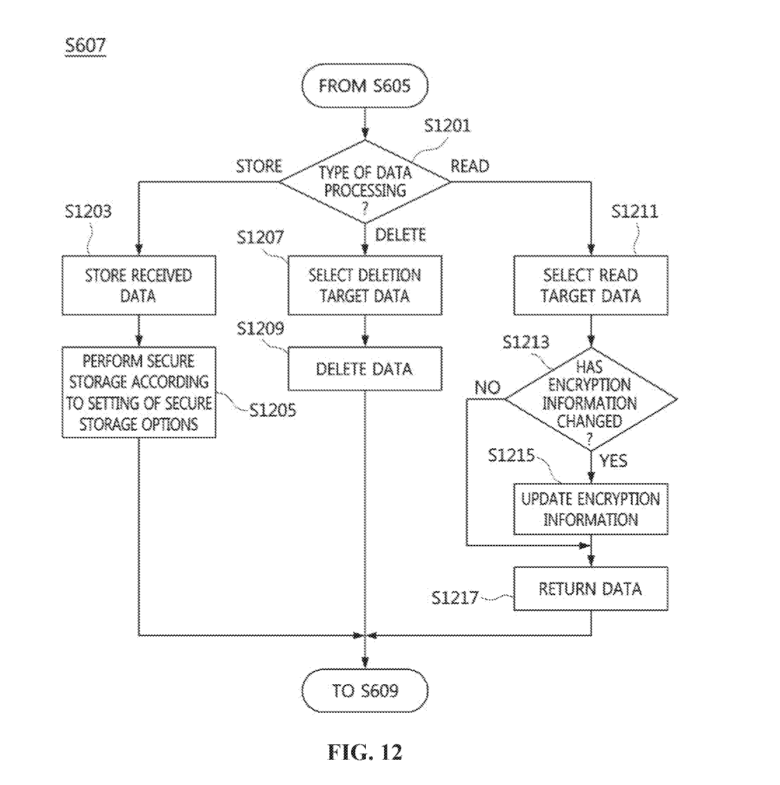

FIG. 12 is an operation flowchart illustrating an example of step S607 of processing data illustrated in FIG. 6.

Referring to FIG. 12, in a procedure at step S607 of processing data illustrated in FIG. 6, the data storage function provision apparatus (see 200 of FIG. 2) determines a command type indicating the type of data processing at step S1201.

If it is determined at step S1201 that the command type is a data storage command, received data is stored at step S1203, and secure storage is performed if necessary according to the setting of secure storage options at step S1205.

If it is determined at step S1201 that the command type is a data delete command, deletion target data is selected at step S1207, and is then deleted at step S1209.

Here, the deletion target data may be selected using a device ID, a data etc.

If it is determined at step S1201 that the command type is a data read command, read target data is selected at step S1211.

Here, the read target data may be selected using a device ID, a data ID, etc.

Next, in the procedure at step S607 of processing data illustrated in FIG. 6, the data storage function provision apparatus (see 200 of FIG. 2) determines whether encryption information for the selected read target data has changed at step S1213. That is, it is determined whether an encryption key at the time at which the read target data is stored (i.e. at the storage time of the read target data) is identical to an encryption key at the time at which a read request is made (i.e. at the read request time).

If it is determined at step S1213 that the encryption information has not changed, the read target data is returned without changing the encryption information at step S1217.

If it is determined at step S1213 that the encryption information has changed, the encryption information is updated at step S 1215, and then the read target data is returned at step S1217.

Here, the update of the encryption information may mean the operation of decrypting encrypted data using the encryption key at the data storage time and encrypting again the decrypted data using the encryption key at the read request time. Further, the newly encrypted data and the encryption key basis information may be updated and stored.

That is, the data stored in the data storage function provision apparatus (see 200 of FIG. 2) is encrypted data, and the encrypted data is not decrypted unless the encryption information is updated, thus enabling high security to be maintained. Further, since pieces of data transmitted/received in a data storage procedure and a data read procedure are different from each other, the data may be more securely protected.

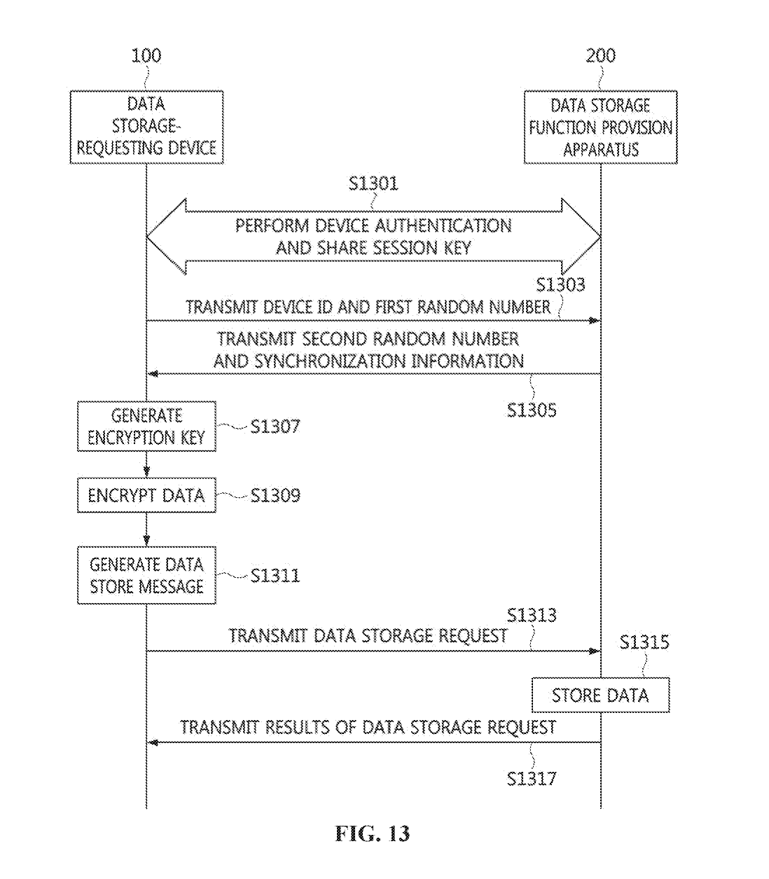

FIG. 13 is an operation flowchart illustrating a data storage method according to an embodiment of the present invention.

Referring to FIG. 13, in the data storage method according to the embodiment of the present invention, the data storage-requesting device 100 and the data storage function provision apparatus 200 perform mutual device authentication and then share a session key with each other at step S1301.

Next, in the data storage method according to the embodiment of the present invention, the data storage-requesting device 100 transmits a device ID and a first random number to the data storage function provision apparatus 200 at step S1303.

Next, in the data storage method according to the embodiment of the present invention, the data storage function provision apparatus 200 transmits a second random number and synchronization information to the data storage-requesting device 100 at step S1305.

Further, in the data storage method according to the embodiment of the present invention, the data storage-requesting device 100 generates an encryption key to be used for data storage using encryption key basis information at step S1307, encrypts storage target data using the generated encryption key at step S1309, and generates a data store message for requesting the data storage function provision apparatus 200 to store data at step S1311.

Further, in the data storage method according to the embodiment of the present invention, the data storage-requesting device 100 sends the data store message to the data storage function provision apparatus 200 at step S1313.

Next, in the data storage method according to the embodiment of the present invention, the data storage function provision apparatus 200 stores data in response to the received data store message at step S1315.

Furthermore, in the data storage method according to the embodiment of the present invention, the data storage function provision apparatus 200 transmits the results of the data storage request to the data storage-requesting device 100 at step S1317.

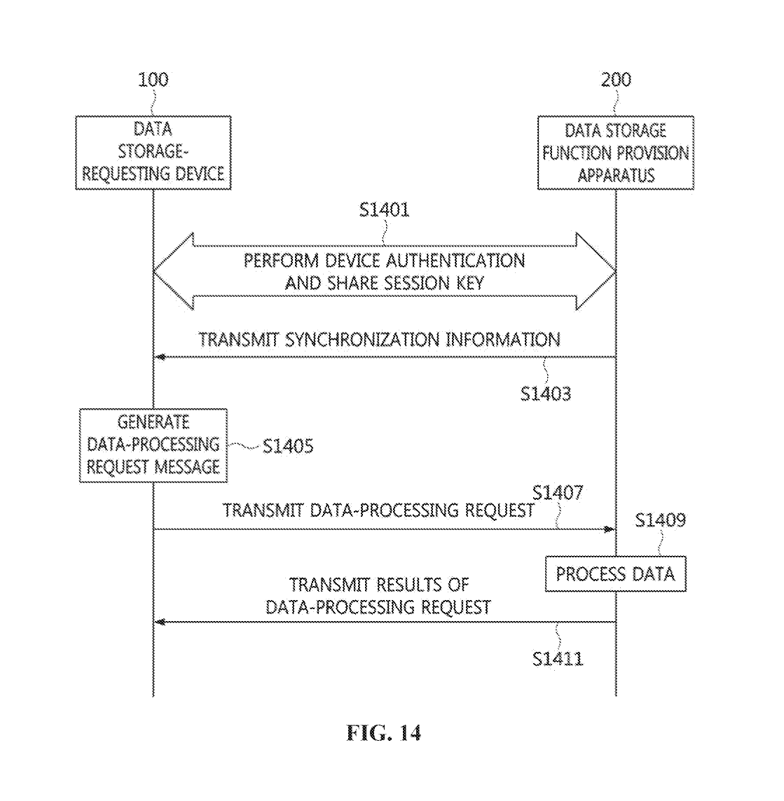

FIG. 14 is an operation flowchart illustrating a data-processing method according to an embodiment of the present invention.

Referring to FIG. 14, in the data-processing method according to the embodiment of the present invention, the data storage-requesting device 100 and the data storage function provision apparatus 200 perform mutual device authentication and then share a session key with each other at step S1401.

Here, data processing may include data deletion, data reading, and data storage other than initial data storage.

Next, in the data-processing method according to the embodiment of the present invention, the data storage function provision apparatus 200 transmits synchronization information to the data storage-requesting device 100 at step S1403. The reason for this is that the data storage-requesting device 100 and the data storage function provision apparatus 200 already have the same device ID, the same first random number, and the same second random number, which are distributed through an initial data storage procedure.

Next, in the data-processing method according to the embodiment of the present invention, the data storage-requesting device 100 generates a data-processing message for requesting the data storage function provision apparatus 200 to process data at step S1405.

Next, in the data-processing method according to the embodiment of the present invention, the data storage-requesting device 100 sends a data-processing request to the data storage function provision apparatus 200 using the data-processing message at step S1407.

Next, in the data-processing method according to the embodiment of the present invention, the data storage function provision apparatus 200 processes data in response to the received data-processing message at step S1409.

Further, in the data-processing method according to the embodiment of the present invention, the data storage function provision apparatus 200 transmits the results of the data-processing request to the data storage-requesting device 100 at step S1411.

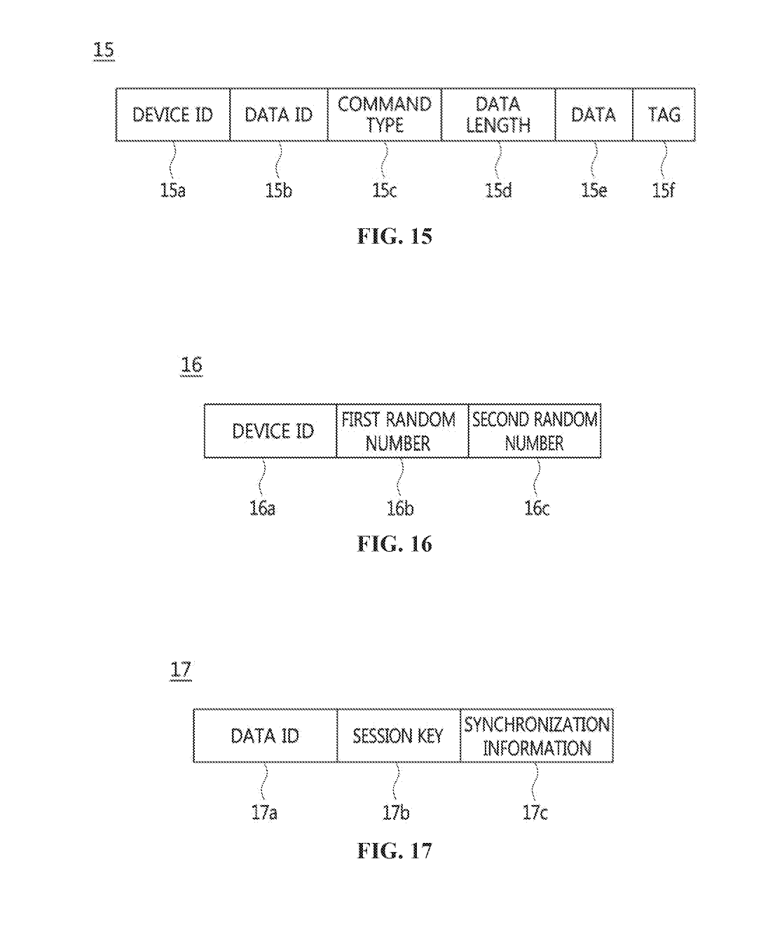

FIG. 15 is a diagram illustrating an example of a data-processing request message according to an embodiment of the present invention.

Referring to FIG. 15, the data-processing request message according to an embodiment of the present invention may include fields such as a device ID 15a, a data ID 15b, a command type 15c, a data length 15d, data 15e, and tag information 15f.

Here, the device ID 15a is an ID for identifying the device that is the data storage-requesting device (see 100 of FIG. 2), and the data ID 15b is an ID for identifying processing target data. The command type 15c may include a data storage (write) command, a data read command, a data delete command, an authentication command, etc. The data length 15d is data-related information and indicates length information of processing target data, and the data 15e is encrypted data of the processing target data. The tag information 15f may include information about whether data is encrypted or whether secure storage is used.

The detailed data-processing request message may differ according to the command type 15c. For example, in the case of the data read command and the data delete command, a data-processing request message may be configured without using the data 15e.

FIG. 16 is a diagram illustrating an example of device setting information according to an embodiment of the present disclosure.

Referring to FIG. 16, the device setting information according to an embodiment of the present invention includes a device ID 16a, a first random number 16b, and a second random number 16c.

Here, the device setting information may be information required by the data storage function provision apparatus (see 200 of FIG. 2) to manage settings of each data storage-requesting device (see 100 of FIG. 2).

FIG. 17 is a diagram illustrating an example of data setting information according to an embodiment of the present disclosure.

Referring to FIG. 17, the data setting information according to an embodiment of the present invention includes a data ID 17a, a session key 17b, and synchronization information 17c.

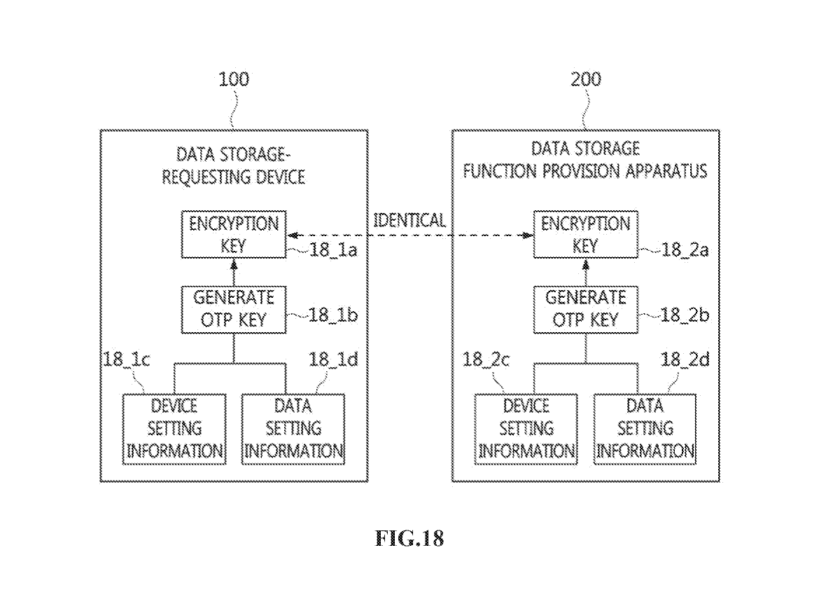

FIG. 18 is a diagram illustrating a one-time key generation method according to an embodiment of the present disclosure.

Referring to FIG. 18, the data storage-requesting device 100 according to an embodiment of the present invention generates a one-time password (OTP) key 18_1b using device setting information 18_1c and data setting information 18_1d, and generates an encryption key using the OTP key 18_1b.

Further, the data storage function provision apparatus 200 according to the embodiment of the present invention generates an OTP key 18_2b using device setting information 18_2c and data setting information 18_2d, and generates an encryption key 18_2a using the OTP key 18_2b.

Here, the device setting information 18_1c used by the data storage-requesting device 100 and the device setting information 18_2c used by the data storage function provision apparatus 200 are identical to each other. Here, the data setting information 18_1d used by the data storage-requesting device 100 and the data setting information 18_2d used by the data storage function provision apparatus 200 are identical to each other. In particular, since the methods by which the data storage-requesting device 100 and the data storage function provision apparatus 200 generate the OTP keys are identical to each other, the generated OTP keys 18_1b and 18_2b are identical to each other. Similarly, since the methods by which the data storage-requesting device 100 and the data storage function provision apparatus 200 generate the encryption keys from the OTP keys are identical to each other, the generated encryption keys 18_1a and 18_2a are identical to each other.

Specific executions, described in the present invention, are only embodiments, and are not intended to limit the scope of the present invention using any methods. For the simplification of the present specification, a description of conventional electronic components, control systems, software, and other functional aspects of systems may be omitted. Further, connections of lines between components shown in the drawings or connecting elements therefor illustratively show functional connections and/or physical or circuit connections. In actual devices, the connections may be represented by replaceable or additional various functional connections, physical connections or circuit connections. Further, unless a definite expression, such as “essential” or “importantly” is specifically used in context, the corresponding component may not be an essential component for the application of the present invention.

In accordance with the present invention, by means of the apparatus and method for storing device data in an IoT environment, a storage function is provided even to IoT devices which do not provide a data storage function, and thus various services which utilize data of IoT devices may be provided.

Further, in accordance with the present invention, by means of the apparatus and method for storing device data in an IoT environment, data may be encrypted and stored using a one-time encryption key, and thus a data security function may be provided, and devices may be protected from various types of forgery and hacking attempts.

Therefore, the spirit of the present invention should not be defined by the above-described embodiments, and it will be apparent that all matters disclosed in the accompanying claims and equivalents thereof are included in the scope of the spirit of the present invention.

What is claimed is:

1. An apparatus for providing a data storage function, comprising:
an authentication unit for performing device authentication with a data storage-requesting device and performing data storage authentication with the data storage-requesting device;
a data storage unit for storing encryption key basis information, used to generate an encryption key for data encryption, and encrypted data;
a request message processing unit for processing a processing request message for the encrypted data received from the data storage-requesting device using the data storage unit; and
a communication unit for receiving the processing request message from the data storage-requesting device and transmitting results of processing to the data storage-requesting device.

2. The apparatus of claim 1, wherein:
the encryption key basis information comprises a device ID for identifying the data storage-requesting device and a data ID for identifying encryption target data, and the authentication unit is configured to exchange the device ID with the data storage-requesting device when the data storage authentication is performed.

3. The apparatus of claim 2, wherein the request message processing unit is configured to:
when the processing request message is a data store message, store encrypted storage target data and encryption key basis information corresponding to the encrypted storage target data in the data storage unit, and
when the processing request message is a data delete message, delete encrypted deletion target data and encryption key basis information corresponding to the encrypted deletion target data which are stored in the data storage unit.

4. The apparatus of claim 3, wherein:
the encryption key basis information further comprises synchronization information for generating a one-time encryption key,
the authentication unit is configured to transmit the synchronization information to the data storage-requesting device when the data storage authentication is performed, and
the encryption key is a one-time encryption key generated using the synchronization information.

5. The apparatus of claim 4, wherein the synchronization information comprises at least one of time synchronization information and counter synchronization information.

6. The apparatus of claim 5, further comprising:
an encryption key generation unit for generating an encryption key using a method identical to that of the data storage-requesting device based on the encryption key basis information; and
an encryption information update unit for, when the processing request message is a data read message, updating encryption information by decrypting encrypted read target data using an encryption key at a storage time and by encrypting the decrypted data using an encryption key at a read time,
wherein the request message processing unit is configured to, when the processing request message is the data read message, return encrypted data, in which the encryption information is updated, to the data storage-requesting device.

7. The apparatus of claim 6, wherein:
the processing request message comprises tag information including at least one of information about whether data is encrypted and information about whether secure storage is used, and
the data storage unit is configured to provide a secure storage function depending on whether the secure storage has been enabled in the tag information.

8. A data storage method comprising:
performing device authentication with a data storage-requesting device;
performing data storage authentication with the data storage-requesting device;
receiving a processing request message for encrypted data from the data storage-requesting device;
processing the processing request message using a data storage unit which stores encryption key basis information, used to generate an encryption key for data encryption, and encrypted data; and
transmitting results of processing to the data storage-requesting device.

9. The data storage method of claim 8, wherein:
the encryption key basis information comprises a device ID for identifying the data storage-requesting device and a data ID for identifying encryption target data, and
performing the data storage authentication is configured to exchange the device ID with the data storage-requesting device.

10. The data storage method of claim 9, wherein processing the processing request message comprises:
when the processing request message is a data store message, storing encrypted storage target data and encryption key basis information corresponding to the encrypted storage target data in the data storage unit; and
when the processing request message is a data delete message, deleting encrypted deletion target data and encryption key basis information corresponding to the encrypted deletion target data which are stored in the data storage unit.

11. The data storage method of claim 10, wherein:
the encryption key basis information further comprises synchronization information for generating a one-time encryption key,
performing the data storage authentication is configured to transmit the synchronization information to the data storage-requesting device, and
the encryption key is a one-time encryption key generated using the synchronization information.

12. The data storage method of claim 11, wherein the synchronization information comprises at least one of time synchronization information and counter synchronization information.

13. The data storage method of claim 12, further comprising:
generating an encryption key using a method identical to that of the data storage-requesting device based on the encryption key basis information; and
when the processing request message is a data read message, updating encryption information by decrypting encrypted read target data using an encryption key at a storage time and by encrypting the decrypted data using an encryption key at a read time,
wherein processing the processing request message is configured to, when the processing request message is the data read message, return encrypted data, in which the encryption information is updated, to the data storage-requesting device.

14. The data storage method of claim 13, wherein:
the processing request message comprises tag information including at least one of information about whether data is encrypted data and information about whether secure storage is used, and
storing the data is configured to provide a secure storage function depending on whether the secure storage has been enabled in the tag information.

15. A data storage-requesting device comprising:
an authentication unit for performing device authentication with a data storage function provision apparatus and performing data storage authentication with the data storage function provision apparatus;
an encryption key generation unit for generating an encryption key using a method identical to that of the data storage function provision apparatus using encryption key basis information;
an encryption/decryption unit for encrypting storage target data or decrypting encrypted data received from the data storage function provision apparatus;
a request message generation unit for generating a processing request message for requesting the data storage function provision apparatus to process data; and
a communication unit for sending the processing request message to the data storage function provision apparatus and receiving results of processing from the data storage function provision apparatus.

16. The data storage-requesting device of claim 15, wherein:
the encryption key basis information comprises a device ID for identifying the data storage-requesting device and a data ID for identifying encryption target data, and
the authentication unit is configured to exchange the device ID with the data storage function provision apparatus when the data storage authentication is performed.

17. The data storage-requesting device of claim 16, wherein the request message generation unit is configured to:
when storage of data is requested, generate a message for requesting the data storage function provision apparatus to store therein encrypted storage target data and encryption key basis information corresponding to the encrypted storage target data, and
when deletion of data is requested, generate a message for requesting the data storage function provision apparatus to delete encrypted deletion target data and encryption key basis information corresponding to the encrypted deletion target data which are stored in the data storage function provision apparatus.

18. The data storage-requesting device of claim 17, wherein:
the encryption key basis information further comprises synchronization information for generating a one-time encryption key,
the authentication unit is configured to receive the synchronization information from the data storage function provision apparatus when the data storage authentication is performed, and
the encryption key is a one-time encryption key generated using the synchronization information.

19. The data storage-requesting device of claim 18, wherein the request message generation unit is configured to, when reading of data is requested, generate a message for requesting the data storage function provision apparatus to update encryption information by decrypting encrypted read target data using an encryption key at a storage time and by encrypting decrypted data using an encryption key at a read time, and to return the read target data.

20. The data storage-requesting device of claim 19, wherein:
the processing request message comprises tag information including at least one of information about whether data is encrypted and information about whether secure storage is used, and
the data storage function provision apparatus is configured to provide a secure storage function depending on whether the secure storage has been enabled in the tag information.
